(19) United States
(12) Patent Application Publication
(10) Pub. No.: US 2008/0183945 A1
(43) Pub. Date: Jul. 31, 2008

(54) FIRMWARE RELOCATION

(76) Inventor: Nathan J. Hughes, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/669,806

(22) Filed: Jan. 31, 2007

(51) Int. Cl. G06F 12/02

(52) U.S. Cl. 711/100

(57) ABSTRACT

A method comprises logic determining a second area of volatile memory into which system firmware is to be relocated. Further, a control method copies the system firmware from a first area of volatile memory to the second area. The logic cannot access the first area.

### BACKGROUND

Many, or all, computer systems comprise one or more instances of executable system firmware that is useful, for example, to provide low-level interfaces to system resources. An example of such system firmware is a Basic Input/Output System (BIOS) code. In many cases, system firmware is stored in non-volatile storage, such as a read-only memory (ROM), copied to volatile memory, and executed from volatile memory.

Computer systems include operating systems that, among other functions, controls access to memory. In many systems, the operating system reserves an area of the volatile memory into which the system firmware is loaded for execution, but otherwise cannot access the area of memory reserved for the system firmware. For example, the operating system cannot perform reads or writes of the reserved area. As a result, the operating system unfortunately cannot relocate the system firmware from one area in memory to another area in the event, for example, that the memory area in which the system firmware is currently located becomes corrupted or for other reasons.

### BRIEF DESCRIPTION OF THE DRAWINGS

For a detailed description of exemplary embodiments of the invention, reference will now be made to the accompanying drawings in which:

FIG. 1 shows a system in accordance with various embodiments;

FIG. 2 shows a volatile memory usable in the system of FIG. 1; and

FIG. 3 shows a method in accordance with various embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to. . . . ” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

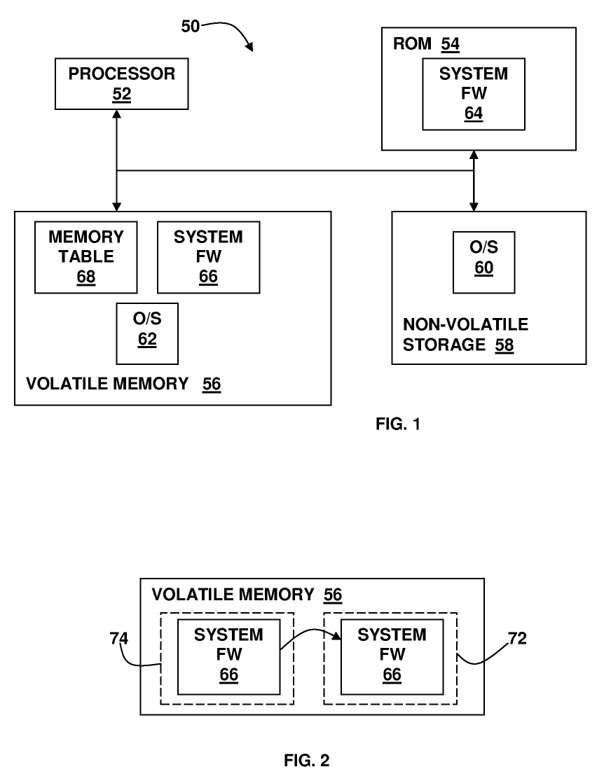

FIG. 1 shows a system 50 in accordance with various embodiments. System 50 comprises a processor 52, a read only memory (ROM) 54, volatile memory 56, and non-volatile storage 58. The processor 52, ROM 54, volatile memory 56, and non-volatile storage 58 are coupled together via one or more bus structures. Any of a variety of architectures is possible for system 50.

The non-volatile storage 58 comprises any suitable storage such as a hard disk drive, a compact disk read-only memory (CD ROM), etc. An operating system 60 is stored in the non-volatile storage 58 and, during an initialization (boot) process for the system 50, an instantiation of the operating system 60 is loaded into volatile memory 56. The instantiation of the operating system in volatile memory is indicated by reference numeral 62. The operating system 62 is executed from volatile memory 56 during run-time. Volatile memory 56 comprises, for example, random access memory (RAM).

The ROM 54 stores the system's firmware 64 (referred to as “system firmware”). System firmware 64 provides various functions such as power-on self-testing, an interface to various low-level functions of the system hardware, etc. In some applications, the system firmware 64 is referred to as a basic input/output system (BIOS). The system firmware 64 comprises executable code (i.e., code that is executed by processor 52). During system initialization, the processor 52 begins executing the system firmware 64 from ROM 54, but at a point during initialization, the system firmware is copied to volatile memory 56 and executed from volatile memory from that point on. The copy of system firmware in volatile memory is indicated by reference numeral 66.

Among other functions, the operating system 62 controls use of volatile memory 56. For instance, the operating system 62 allocates areas of memory for various purposes. One such allocation is for the system firmware 66. The operating system 62, during initialization, allocates an area of memory 56 into which the system firmware 66 is stored. The area of memory allocated for the system firmware 66 is not, however, accessible to the operating system 66. For example, the operating system does not and/or cannot perform read and/or write transactions to the area of memory allocated for the system firmware 66.

For any of a variety of reasons, it may be desirable to relocate the system firmware 66 from its current area to a new area. Such reasons comprise, for example, a hardware memory defect with one or more memory locations into which the system firmware 66 is stored. Because, however, the operating system 66 does not have access to the system firmware's memory area, the operating system 66 cannot directly relocate the system firmware. Relocating the system firmware is also referred to herein as migrating or copying the system firmware. FIG. 2 illustrates the relocation of the system firmware 66 from a first area 72 to a second area 74.

In accordance with various embodiments, the system 50 relocates the system firmware from its current area (a “first” area) to a new area (the “second” area) of memory without using, or requiring direct access (e.g., reads, writes), by the operating system. The system firmware 66 uses control logic to relocate itself. In some such embodiments, the system 50 implements the Advanced Configuration and Power Interface (ACPI) standard. ACPI generally comprises a power management specification that allows the operating system to control the amount of power distributed to various of the system's devices. According to the ACPI standard, the operating system is provided with various methods for controlling the system's hardware resources. In addition to predetermined methods, a device specific method (“_DSM”) is also provided to the operating system and can be configured by the system architect as desired. In accordance with various embodiments, the _DSM control method comprises the control logic mentioned above that is used to relocate the system firmware from one location in memory to another. The _DSM control method is part of the system firmware code itself. The operating system is provided with an interface “call” to the _DSM method and, through the call, can pass one or more values to the _DSM method.

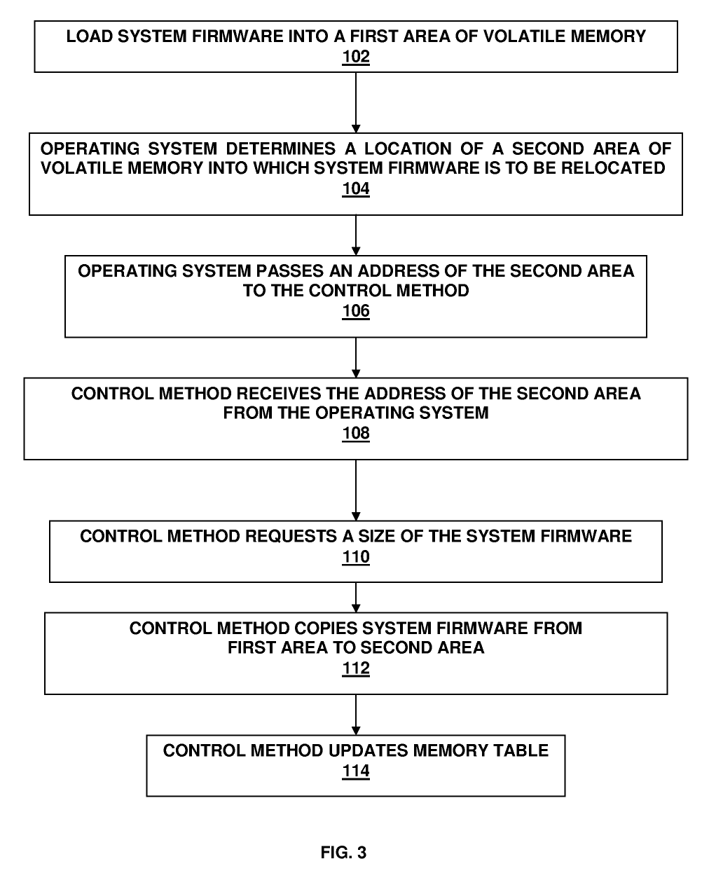

FIG. 3 illustrates a method 100 of relocating the system firmware from a first area of volatile memory 56 to a second area of volatile memory without requiring direct access (e.g., reads, writes) by the operating system of the first or second areas of memory (i.e., the areas in which the system firmware is stored). At 102, the method comprises loading the system firmware into the first areas of the memory 56. This action occurs during system initialization as explained above. If, at a later time, it is indicated that the system firmware 66 should be located from the first area to a second area, at 104 the method then comprises the operating system 62 determining the second area of memory into which the system firmware is to be relocated. This action comprises, for example, the operating system 62 determining an address of such a second area (e.g., the beginning address of the second area).

At 106, the method comprises the operating system passing the address of the second area to the control method (e.g., _DSM). The control method receives the address of the second area at 108, and requests the size of the system firmware at 110. The size informs the control method how many bytes to copy from the first area to the second area. At 112, the control method copies the system firmware from the first area to the second area.

Copying the system firmware comprises, in at least one embodiment, making a copy of the system firmware thereby resulting in two copies of the system firmware being stored in memory 56—the original and the new copy. In some embodiments, the original is erased (e.g., overwritten with 0's) and in other embodiments, the original remains intact but not used.

FIG. 1 illustrates that a memory table 68 is stored in volatile memory 56. The memory table 68 records, possibly among other items, the address of each executable code, including the system firmware. Thus, at 114 in FIG. 3, the control method updates the memory table to indicate the new location (at the second area of memory 56) of the system memory. The operating system 62 can release the first area for use in other regards, besides for the system firmware, or preclude future use of the first area altogether.

In other embodiments, logic or other software (collectively “logic”), besides the operating system, can make the call into the system firmware's control method to cause the relocation of the system firmware to occur. Such logic also may not be able to access directly (e.g., reads, writes) the first and/or second areas. Also, the system firmware relocation can occur during which time the system firmware remains fully operational. In some embodiments, the operating system continues making calls to the original copy while the original copy is being relocated. Once the relocation completes and the operating system determines that all outstanding calls to the original copy of the system firmware have completed, the memory table is updated thereby causing the operating system to begin using the new copy.

In other embodiments, a “lock” is implemented for the system firmware at the beginning of the system firmware relocation process. The lock prevents the operating system from making calls to the system firmware, so that the system firmware can be relocated without interruption. Upon completion of the relocation process, the lock is released and calls can proceed using the new copy of the system firmware.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method, comprising:
logic determining a second area of volatile memory into which system firmware is to be relocated;
a control method copying the system firmware from a first area of volatile memory to said second area;
wherein said logic cannot access said first area.

2. The method of claim 1 further comprising said logic determining an address of said second area.

3. The method of claim 1 further comprising said logic passing an address of said second area to said control method.

4. The method of claim 1 further comprising said control method receiving an address of said second area from the logic.

5. The method of claim 1 further comprising said control method requesting a size of said system firmware.

6. The method of claim 1 further comprising said control method updating a memory table to reflect the location of said system firmware after being copied.

7. A system, comprising:
memory;
system firmware stored in a first area of said memory;
an operating system that determines a second area of said memory into which said system firmware is to be relocated, said operating system being unable to access said first area;
control logic that copies the system firmware from the first area of said memory to said second area.

8. The system of claim 7 wherein said operating system is unable to access said second area after said system firmware is copied to said second area.

9. The system of claim 7 wherein said operating system determines an address of said second area.

10. The system of claim 7 wherein said operating system provides an address of said second area to said control logic.

11. The system of claim 7 wherein said control logic receives an address of said second area from the operating system.

12. The system of claim 7 wherein said control logic requests a size of said system firmware.

13. The method of claim 7 wherein said control method updates a memory table to indicate the location of said system firmware after said system firmware has been copied.

14. A system, comprising:
means for storing system firmware; and
means for relocating said system firmware within said means for storing;
wherein said system firmware is inaccessible to an operating system before being relocated.

15. The system of claim 14 further comprising means for requesting a size of said system firmware.

16. The system of claim 14 further comprising means for receiving an address of an area in said means for storing into which said system firmware is relocated.

17. The system of claim 14 further comprising means for providing an address of an area in said means for storing into which said system firmware is relocated.

18. The system of claim 14 further comprising means for updating a memory table to indicate a location of said system firmware after said system firmware has been relocated.

19. The system of claim 14 wherein said system firmware is inaccessible to the operating system after being relocated.

20. The system of claim 14 wherein said system firmware can be neither read nor written by said operating system before being relocated.
